(19) United States
(12) Patent Application Publication
(10) Pub. No.: US 2021/0397426 A1
(43) Pub. Date: Dec. 23, 2021

(54) EFFICIENT DEPENDENCY MANAGEMENT FOR SOFTWARE DEVELOPMENT ENVIRONMENTS

(71) Applicant: Uber Technologies, Inc., San Francisco, CA (US)

(72) Inventors: Peng Du, Santa Clara, CA (US); Yu Wang, San Jose, CA (US); Taikun Liu, Sunnyvale, CA (US); Atul Gupte, San Francisco, CA (US)

(21) Appl. No.: 17/353,069

(22) Filed: Jun. 21, 2021

Related U.S. Application Data
(60) Provisional application No. 63/041,743, filed on Jun. 19, 2020.

(51) Int. Cl. G06F 8/61; G06F 8/41

(52) U.S. Cl. CPC G06F 8/61; G06F 8/433

(57) ABSTRACT

A dependency management system preserves and installs software project environments. The dependency management system stores snapshots of project environments on client devices which include one or more software packages. A project environment snapshot includes a dependency graph representing the dependencies of the project environment. The dependency management system may manage a project environment on a client device and update a dependency graph to reflect the dependencies of currently installed packages. As part of the updating of the dependency graph, the dependency management system may automatically resolve dependency conflicts resulting from one or more dependencies of the project environment. The dependency management system further provides project environment snapshots to client systems for installing corresponding project environments.

### CROSS REFERENCE TO RELATED APPLICATIONS

This application claims the benefit of U.S. Provisional Application No. 63/041,743, filed Jun. 19, 2020, which is incorporated by reference herein.

### BACKGROUND

In order to take advantage of existing software, software developers often install distributions of existing software, or software packages, in a software development environment for a custom software project. Software packages installed in a software development environment may depend on other software packages (i.e., they have dependencies). A development environment for a particular project may include many software packages, which may in turn have many individual dependencies.

Dependency management systems aid developers by automating processes involved in installing and using software packages and their dependencies in development environments, as well as resolving dependency conflicts which arise. However, existing dependency management systems maintain representations of packages and their dependencies for software projects which are difficult to reproduce and distribute for other software projects (e.g., a plain text file listing dependencies). Other existing dependency management systems may bundle packages and their dependencies in formats which are demanding in terms of computational and storage resources to create, maintain, and distribute. As such, dependency management systems which improve reproduction and distribution of software development environments for custom software projects are needed.

### SUMMARY

A dependency management system preserves and installs software project environments. In particular, the dependency management system stores snapshots of project environments on client devices which include one or more software packages. A project environment snapshot includes a dependency graph representing the dependencies of the project environment. The dependency management system may manage a project environment on a client device and update a dependency graph to reflect the dependencies of currently installed packages. As part of the updating of the dependency graph, the dependency management system may automatically resolve dependency conflicts resulting from one or more dependencies of the project environment.

The dependency management system may generate and store a snapshot for a monitored project environment in response to a request from a client device. Additionally, the dependency management system may update a previously stored project environment snapshot to reflect changes to the project environment on the client device. Furthermore, the dependency management system may provide stored project environment snapshots to the same device or different client devices, which may then be used to install the project environment. In some embodiments, the dependency management system caches software packages corresponding to one or more project environments. In this case, the dependency management system may provide one or more compressed packages corresponding to a project environment to a client device requesting to install the project environment. Among other advantages, by providing some or some or all of automatic dependency conflict resolution, storage of snapshots including the current dependency graph corresponding to a working project environment, and caching software packages corresponding to snapshots, the dependency management system enables efficient management of dependencies and rapid switching between different project environments by a computing device.

### BRIEF DESCRIPTION OF DRAWINGS

FIG. 1 illustrates a computing environment for a dependency management system, according to one embodiment.

FIG. 2 is a block diagram illustrating the development environment module of FIG. 1, according to one embodiment.

FIG. 3 is a block diagram illustrating a dependency management module of FIG. 1, according to one embodiment.

FIG. 4 is a flowchart of a process for generating a project environment snapshot and providing it for installation, according to one embodiment.

FIG. 5 is a flowchart of a process for generating a dependency snapshot, according to one embodiment.

FIG. 6 is a flowchart of a process for installing a project environment using a dependency snapshot, according to one embodiment.

FIG. 7 is a block diagram illustrating physical components of a computer used as part or all of the entities depicted in FIG. 1, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Computing Environment

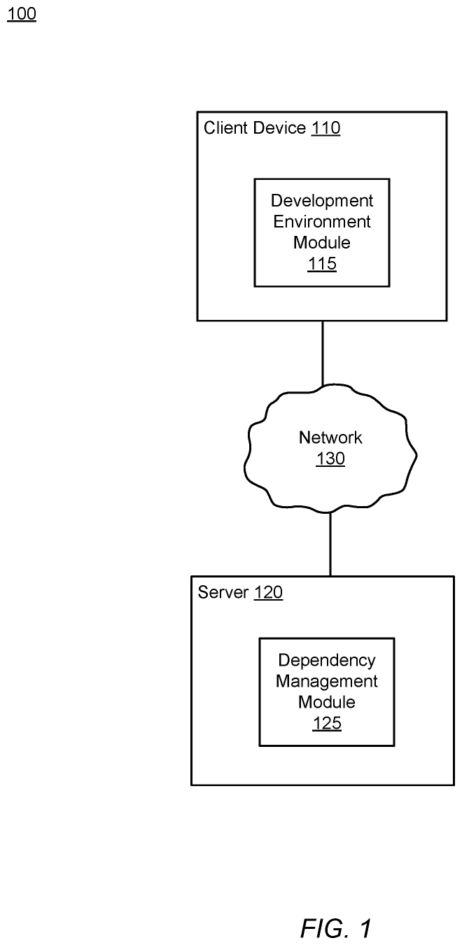

FIG. 1 illustrates one embodiment of a computing environment for a dependency management system 100. In the embodiment shown, the dependency management system 100 includes a client device 110 and a server 120, connected via a network 130. In other embodiments, the dependency management system 100 may include different or additional elements. Furthermore, the functionality may be distributed among the elements in a different manner than described.

The client device 110 is a computing device such as a smart phone, laptop computer, desktop computer, or any other device that can access the server 120 through the network 130. In the embodiment shown, the client device 110 includes a development environment module 115. In FIG. 1, only one client device 110 is shown for illustrative purposes. However, any number of client devices 110 may interact with the server 120.

The development environment module 115 facilitates software development in one or more programming languages on the client device 110. In particular, the development environment module 115 provides a development environment for creating custom software projects. The development environment module 115 may include an integrated development environment (IDE) which performs various common functions of IDEs (e.g., scripting, file management, debugging, compiling, program execution, software package installation, etc.). Particularly, the development environment module 115 may be the client side of an online IDE application, such as an IDE hosted by the server 120. For example, the development environment module 115 may be an IDE application installed on the client device 110, a web-based IDE accessed through a browser, or some combination thereof. In other embodiments, some or all of the processes performed by the development module 115 described herein may be performed entirely or in part on a server.

In embodiments, the development environment module 115 maintains one or more development environments for custom software projects (i.e., a project environment). A project environment may include one or more software packages installed on the client device 110 which are directly depended on by software developed using the project environment (i.e., project packages). For example, a user of the client device 110 may install various project packages for a project environment through the development environment module 115. Furthermore, the installed project packages may each have one or more software dependencies (i.e., additional software packages or libraries which the project packages depend on).

The development environment module 115 may facilitate installation of the relevant dependencies for each installed package, such as automatically installing the dependencies or prompting a user of the client device 110 to install the dependencies. Information describing the project packages and project package dependencies of a software project may be represented in various formats. For example, the characteristics of the project packages (e.g., package names and other metadata) and intended versions (e.g., versions installed or specified by the user) may be stored in a manifest (e.g., a manifest file). Additionally, or alternatively, a representation of a dependency graph for the dependencies of the project packages may be stored, such as in a dependency lock file. The development environment module 115 may generate and maintain the manifest, dependency graph, and any additional or different information describing a project environment. Additionally, information describing a project environment may be obtained, modified, maintained, stored, or otherwise processed by the server 120.

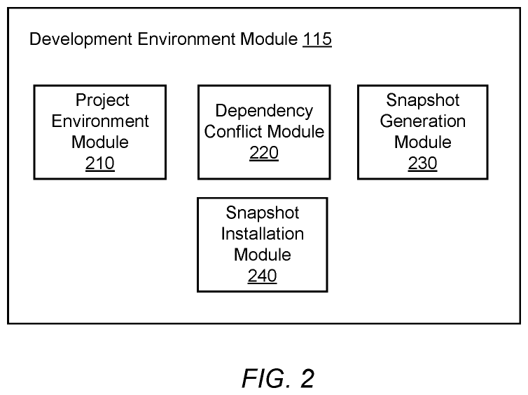

The development environment module 115 communicates with the server 120 to facilitate saving or installing an instance of a project environment on the client device 110. In embodiments, the development environment module 115 provides information describing current project packages and dependencies for a project environment to the server 120 (i.e., a project environment snapshot). In the same or different embodiments, the development environment module 115 requests a project environment snapshot corresponding to an instance of a project environment created by the requesting client device 110 or another client device 110. In embodiments, the development environment module 115 provides a user interface for display by the client device 110 which includes interface elements for creating a snapshot of a project environment. Additionally, or alternatively, the development environment module 115 may provide an interface including elements for selecting a snapshot for installation on the client device 110 from a set of snapshots stored by the server 120. The development environment module 115 may store information describing a project environment locally, such as a current manifest or dependency graph. Generating and installing project environment snapshots in a development environment is described in greater detail below with reference to the development environment module 115, the dependency management module 125, and FIGS. 2-6.

In some embodiments, the development environment module 115 may provide additional tools for software development, such as data analytics or other data processing for software projects (e.g., data visualizations, machine learning models, statistical analyses, etc.). In these embodiments the development environment module 115 may obtain data from the server 120 or other third-party systems.

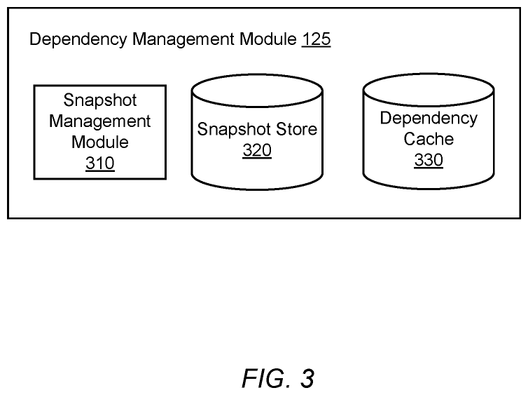

The server 120 manages development environments on one or more client devices 110. In the embodiment shown in FIG. 1, the server 120 includes a dependency management module 125, which performs the relevant processes for managing project environment snapshots corresponding to project environments installed on the client device 110. In embodiments, the dependency management module 125 stores or updates project environment snapshots corresponding to local project environments on client devices 110 based on requests or information received from the client devices 110. In the same or different embodiments, the dependency management module 125 makes stored project environment snapshots available to the same or different client devices 110 for installing corresponding project environments in a local software development environment (e.g., the development environment module 115). The dependency management module 125 may communicate with the development environment module 115 over the network 130 via a generic interface, such as an application programming interface (API). As such, the dependency management module 125 may perform the processes described herein for various software development environments including software developed using various languages. The dependency management module 125 is described in greater detail below with reference to FIG. 3.

The network 130 connects the client device 110 to the server 120. The network 130 may be any suitable communications network for data transmission. In an embodiment such as that illustrated in FIG. 1, the network 130 uses standard communications technologies or protocols and can include the internet. In another embodiment, the entities use custom or dedicated data communications technologies.

FIG. 2 is a block diagram of one embodiment of the development environment module 115. In the embodiment shown, the development environment module 115 includes a package installation module 210, a dependency conflict module 220, a snapshot generation module 230, and a snapshot installation module 240. In other embodiments, there may be different or additional components than those shown in FIG. 2. Furthermore, some or all of the operations described for the development environment module 115 below may be performed on the server 120, or another suitable device.

The project environment module 210 facilitates creation and use of project environments on the client device 110. In embodiments, the project environment module 210 maintains information describing a current state of each software project environment, such as a current manifest or a dependency graph. When the state of a given project environment changes, the project environment module 210 may update the information describing the current state of the software project environment, such as updating the manifest when a project package is installed or removed, or updating the dependency graph based on the dependencies of a project package which was installed or removed. In order to update the dependency graph when a new project package is installed, the project environment module 210 may use the dependency conflict module 220, as described in greater detail below.

The dependency conflict module 220 resolves conflicts in the dependencies of project packages of a project environment. The dependency conflict module 220 may receive a current dependency graph for a project environment and the dependencies of a newly installed project package for the project environment. Based on the dependencies of the newly installed project environment, the dependency conflict module 220 may determine whether any conflicts exist between the current dependency graph and the new dependencies. Furthermore, after determining there are dependency conflicts, the dependency conflict module 220 may determine a resolution of the dependency conflicts. Examples of dependency conflicts include dependency version conflicts between project packages, circular dependencies between project packages, diamond dependencies between project packages, and installation order conflicts between project packages. The dependency conflict module 220 may update the dependency graph directly to include the dependencies of the new project package and a resolution of any determined dependency conflicts, or may provide a resolution of any determined dependency conflicts to another component of the development environment module 115 (e.g., the project environment module 210). The dependency conflict module 220 may use any suitable techniques for resolving dependency conflicts in a dependency graph, such as constraint satisfaction algorithms, depth first search algorithms, forward checking algorithms, and any other techniques used by dependency management systems for conflict resolution.

The dependency conflict module 220 may be unable to automatically resolve some dependency conflicts for a project environment. In embodiments, the dependency conflict module 220 prompts a user of the client device 110 to manually resolve dependency conflicts which it was unable to resolve automatically. For example, the dependency conflict module 220 may display on a screen of the client device 110 describing one or more unresolved dependency conflicts for the project environment. If the user of the client device 110 manually resolves the unresolved dependency conflicts for the project package, the dependency conflict module 220 or another component of the development environment module 115 updates the dependency graph to reflect the manual resolution.

The snapshot generation module 230 facilitates generation of project environment snapshots. The snapshot generation module 230 may generate a snapshot for a project environment in response to a request from a user of the client device 110. For example, a user of the client device 110 may initiate generation of a snapshot for a project environment through an interaction with the development environment module 115 (e.g., selecting a “generate snapshot” button). Alternatively, or additionally, the snapshot generation module 230 may periodically generate a snapshot for a project environment automatically. In order to generate a project environment snapshot, the snapshot generation module 230 may obtain current information describing the project environment from the project environment module 210 or another component of the development environment module 115. In particular, the snapshot generation module 230 may generate a project environment snapshot including an instance of a current dependency graph for the project environment, an instance of a current manifest for the project environment, or other metadata describing the project environment. In some embodiments, the snapshot generation module 230 includes information describing the project environment in the generated project environment snapshot, such as a project environment title or a description. The snapshot generation module 230 may prompt or otherwise direct a user of the client device 110 to provide this information or otherwise obtain the information from the user. After generating a project environment snapshot, the snapshot generation module 230 provides the generated project environment snapshot to the server 120.

In some embodiments, the snapshot generation module 230 provides information describing updates to a previously generated snapshot to the server 120. For example, the snapshot generation module 230 may generate an initial project environment snapshot for a project environment. Then, after the project environment is modified in some way (e.g., project packages are added, removed, updated, etc.), the snapshot generation module 230 can provide information to the server 120 describing the updates. The server 120 may use the provided updates to modify a stored project environment snapshot to reflect the changes, which is described in greater detail below with reference to the snapshot management module 310. As an example, updates to a project environment may include adding or removing packages from the project environment or changes to dependencies of packages of the project environment. In the same or different embodiments, the snapshot generation module 230 generates additional project environment snapshots for a project environment and provides the additional project environment snapshots to the server 120. For example, the snapshot generation module 230 may generate a first project environment snapshot for project environment with a project package at version A and a second project environment snapshot for a project environment with a particular project package at version B. The snapshot generation module 230 can provide both the first and second project environment snapshots to the server 120 for storage.

In some embodiments, the snapshot generation module 230 or another component of the development environment module 115 requests that the server 120 store compressed versions of one or more project packages and their dependencies for a project environment (i.e., a compressed project environment). For example, the server 120 may generate a ZIP file including a project package and all or some of its dependencies. Compressed snapshots are discussed in greater detail below with reference to the snapshot installation module 240 and the dependency management module 125.

The snapshot installation module 240 installs project environments in the development environment module 115 using development environment snapshots. In embodiments, the snapshot installation module 240 requests a project environment snapshot from the server 120. For example, the snapshot installation module 240 may receive information describing project environment snapshots stored by the server 120, such as a list of names or project packages for project environment snapshots stored by the server 120. The client device 110 may display the provided information and allow a user of the client device 110 to select a project environment for installation. After requesting a project environment snapshot the snapshot installation module 240 receives a project environment snapshot from the server 120 and uses the project environment snapshot to install the corresponding project environment. In particular, the snapshot installation module 240 uses a manifest or a dependency graph included in the received project environment snapshot to install the project packages and dependencies for the project environment. The manifest or dependency graph may specify an installation order, project package versions, dependency versions, and any other installation information which avoids dependency conflicts in the installed project environment.

In some embodiments, the snapshot installation module 240 queries the server 120 to determine whether a compressed project environment is stored by the server 120 for a selected project environment. In embodiments, if a compressed project environment is stored by the server 120, the snapshot installation module 240 obtains the compressed project environment including one or more compressed project packages and dependencies from the server 120. The snapshot installation module 240 decompresses (e.g., unzips) the received compressed project environment to initialize the project environment. In the same or different embodiments, if a compressed project environment is not stored by the server 120, the snapshot installation module 240 obtains the project environment snapshot and uses it to install the project environment, as described above. In this case, the snapshot installation module 240 may further automatically request that the server 120 compress and store the project environment for future installations.

FIG. 3 is a block diagram illustrating one embodiment of the dependency management module 125. In the embodiment shown, the dependency management module 125 includes a snapshot management module 310, a snapshot store 320, and a dependency cache 330. In other embodiments, there may be different or additional components than those shown in FIG. 3. Furthermore, some or all of the operations described for the dependency management module 125 below may be performed on the client device 110, or another suitable device.

The snapshot management module 310 maintains project environment snapshots for client devices 110. In embodiments, the snapshot management module 310 receives a new project environment snapshot from a client device 110 and stores the project environment snapshot in the snapshot store 320. In the same or different embodiments, the snapshot management module 310 receives information describing updates to a previously stored project environment snapshot from a client device 110. For example, the client device 110 may provide an updated manifest or dependency graph to the snapshot management module 310 after a project package was installed or removed. In this case, the snapshot management module 310 can update the previously stored project environment snapshot based on the updated dependency graph. In further same or different embodiments, snapshot management module 310 receives requests for project environment snapshots stored in the snapshots store 320 from a client device 110 and provides the requested project environment snapshots to the client device 110. In order to enable the client device 110 to request a project environment snapshot, the snapshot management module 310 may provide metadata for project environment snapshots stored in the snapshots store 320 to the client device 110. In this case, the development environment module 115 may use the received metadata for project environment snapshots to install the project environments.

In some embodiments, the snapshot management module 310 stores compressed project environments in the dependency cache 330. In some embodiments, the snapshot management module 310 receives queries from a client device 110 regarding whether a compressed project environment is stored in the dependency cache 330 for a project environment snapshot selected for installation. If a compressed project environment is stored in the dependency cache 330, the snapshot management module 310 provides the compressed project environment to the client device 110. If not, the snapshot management module 310 may automatically provide the project environment snapshot to the client device 110 or may notify the client device 110 that the compressed environment snapshot was not available. In the same or different embodiments, the snapshot management module 310 automatically determines whether a compressed project environment is stored when a project environment snapshot is requested by a client device 110.

In some cases, the snapshot management module 310 may automatically store a compressed package environment in the dependency cache 330 when storing a project environment snapshot. Alternatively, the snapshot management module 310 may store a compressed package environment in response to a request from the client device 110.

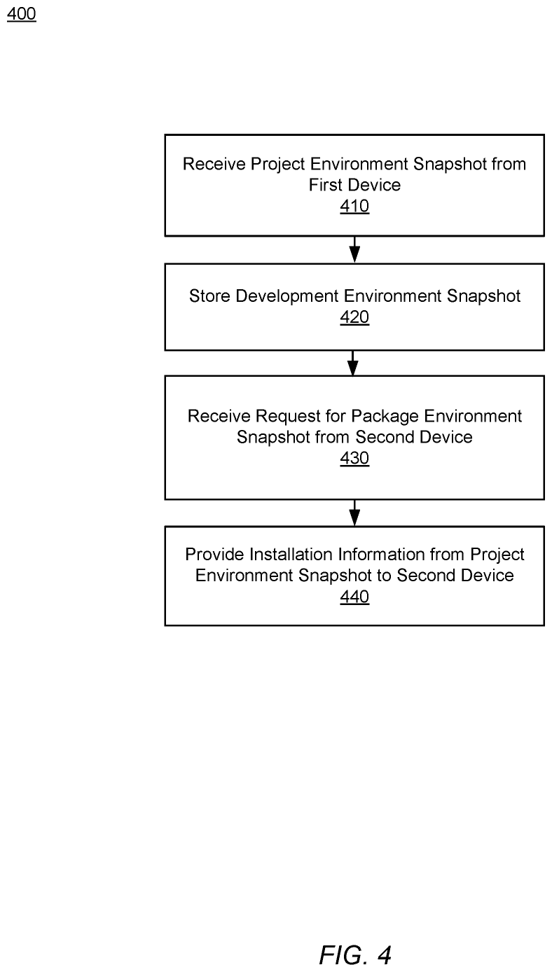

FIG. 4 is a flowchart illustrating a method 400 for generating a project environment snapshot for installation, according to one embodiment. The steps of FIG. 4 are illustrated from the perspective of the dependency management module 125 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the dependency management module 125 receiving 410 a project environment snapshot from a first device (e.g., the client device 110). For example, the project environment may have been created by a user of the first device through an IDE (e.g., the development environment module 115). Furthermore, the first device may have generated a project environment snapshot for the project environment including an instance of a dependency graph or a manifest for the project environment, such as in response to a user of the first client device requesting to generate and store the project environment snapshot. The dependency management module 125 stores 420 the project environment snapshot (e.g., in the snapshot store 320).

At a later time, the dependency management module 125 receives 430 a request for the package environment snapshot from a second device. For example, a user of the second device may select the package environment snapshot from a list of one or more package environment snapshots. In response to the request for the project environment snapshot, the dependency management module 125 provides 440 installation information included in the requested project environment snapshot to the second device. For example, the dependency management module 125 may provide the stored manifest or dependency graph for the project environment snapshot. The second device may then install the project environment (e.g., install the project packages and dependencies) using the provided installation information.

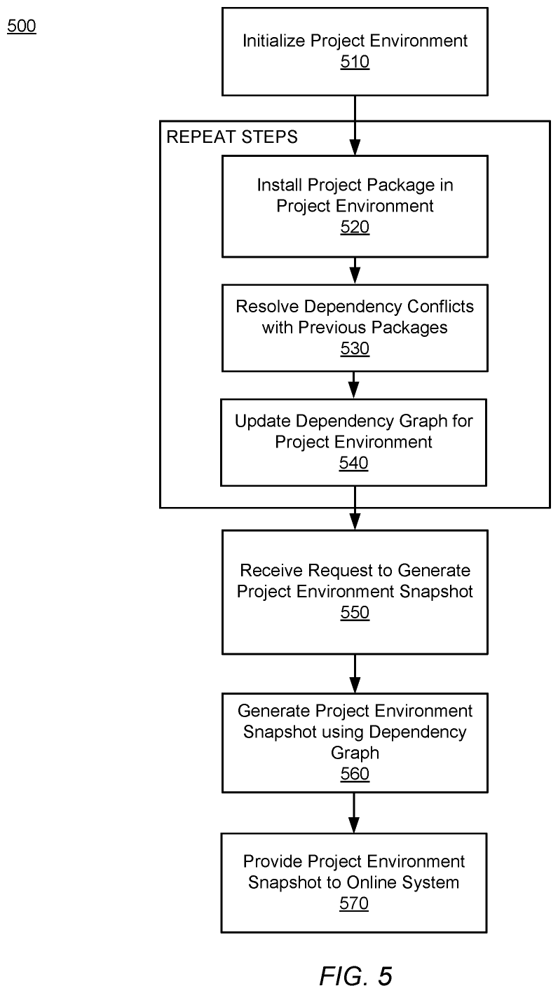

FIG. 5 is a flowchart illustrating a method 500 for generating a snapshot, according to one embodiment. The steps of FIG. 5 are illustrated from the perspective of the client device module 110 performing the method 500. However, some or all of the steps may be performed by other entities or components. In addition, some embodiments may perform the steps in parallel, perform the steps in different orders, or perform different steps.

In the embodiment shown in FIG. 5, the method 500 begins with the client device 110 initializing 510 a project environment. In one embodiment, the development environment module 115 initializes a project environment for software development on the client device 110. At some time after initializing the project environment, the client device 110 installs 520 a project package for a project environment. For example, a user of the client device 110 may install a new project package in the project environment. Based on the dependencies of the installed project package, the client device 110 resolves 530 any dependency conflicts with packages previously installed for the project environment. For example, the development environment module 115 may identify and resolve 530 dependency conflicts by comparing the dependencies of the new project package to a dependency graph representing the dependencies of previously installed project packages. After having resolved 530 any identified dependency conflicts, the client device 110 updates 540 a dependency graph for the project environment to reflect the dependencies of the installed project package. The client device 110 may repeat steps 520, 530, and 540 as part of the monitoring by the dependency management system each time a project package is installed for the project environment.

The client device 110 receives 550 a request to generate a project environment snapshot for the project environment. In one embodiment, a user of the client device 110 performs an interaction with the client device 110 requesting a project environment snapshot be generated for the project environment. Based on the received 550 generation request, the client device 110 generates 560 a project environment snapshot for the project environment using the dependency graph for the project environment. For example, the client device 110 may generate a snapshot including a static version of a dependency graph for the project environment. Having generated the project environment snapshot, the client device module 110 provides 570 the snapshot to an online dependency management system (e.g., the server 120).

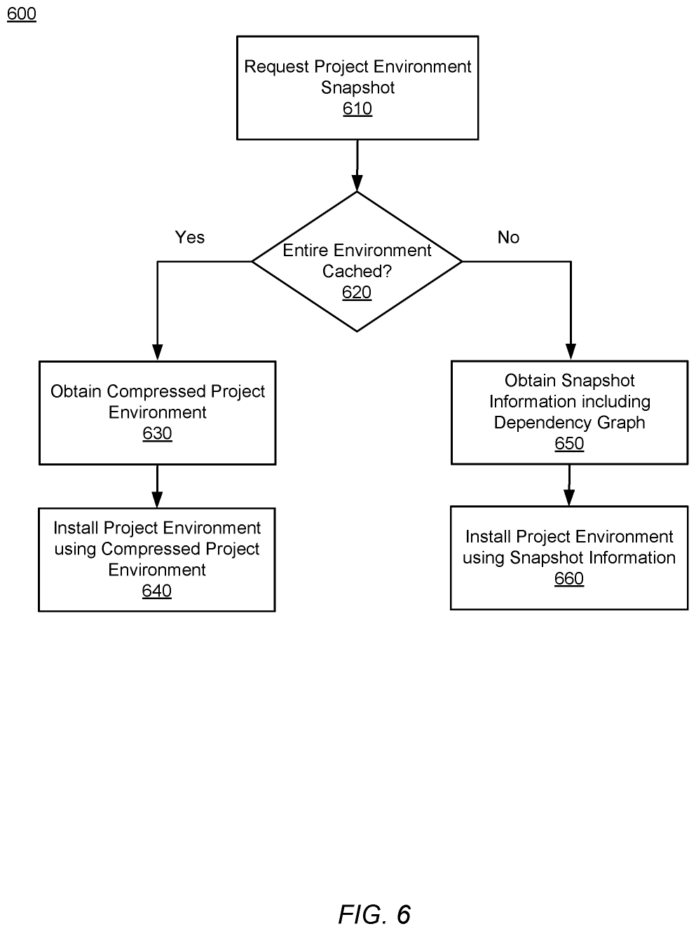

FIG. 6 is a flowchart illustrating a method 600 for installing a project environment using a project environment snapshot, according to one embodiment. The steps of FIG. 6 are illustrated from the perspective of the client device 110 performing the method 600. However, some or all of the steps may be performed by other entities or components. In addition, some embodiments may perform the steps in parallel, perform the steps in different orders, or perform different steps.

In the embodiment shown in FIG. 6, the client device 110 requests 610 a project environment snapshot from the server 120. In one embodiment, a user of the client device 110 selects the project environment snapshot from a list of one or more project environment snapshots stored in the snapshot store 320. The client device 110 determines 620 whether the entire project environment is cached. If the requested project environment is cached, the client device 110 obtains 630 the compressed project environment corresponding to the snapshot from the server 120. Using the compressed project environment, the client device 110 installs 640 the project environment on the client device. For example, installing 640 the project environment may include decompressing one or more compressed packages included in the compressed project environment.

If the requested project environment snapshot is not cached, the client device 110 obtains 650 snapshot information including the dependency graph for the project environment. In one embodiment, the development environment module 115 obtains a manifest and the dependency graph included in the project environment snapshot. Using the snapshot information, the client device 110 installs 660 the project environment. For example, the development environment module 115 may install the project packages and each of their dependencies as indicated by the manifest or the dependency graph.

### Computer Architecture

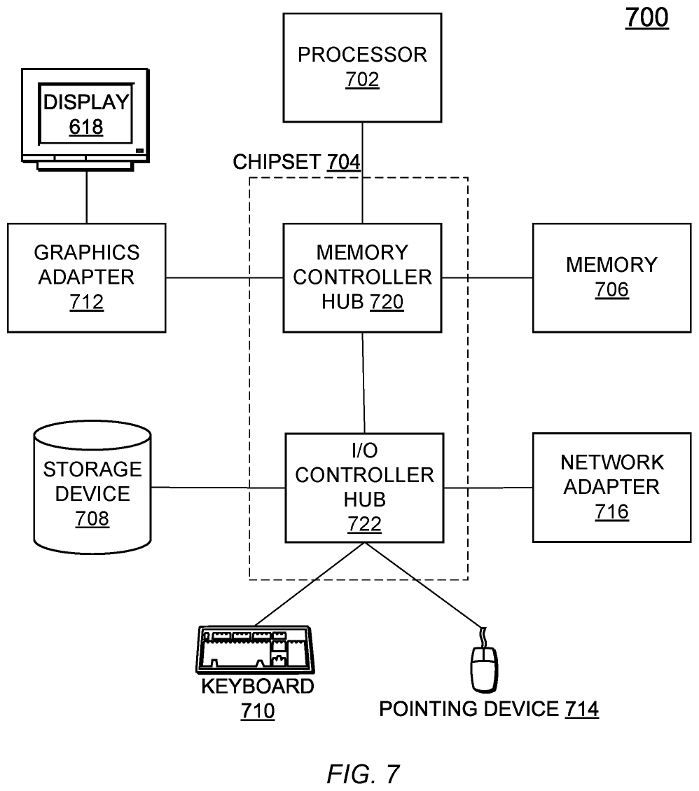

FIG. 7 is a block diagram illustrating physical components of a computer used as part of all of the entities depicted in FIG. 1, according to one embodiment. Illustrated are at least one processor 702 coupled to a chipset 704. Also coupled to the chipset 704 are a memory 706, a storage device 708, a graphics adapter 712, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The graphics adapter 712 displays images and other information on the display 718. The network adapter 716 couples the computer 700 to a local or wide area network.

As is known in the art, a computer 700 can have different or other components than those shown in FIG. 7. In addition, the computer 700 can lack certain illustrated components. In one embodiment, a computer 700 acting as a server may lack a graphics adapter 712, or display 718, as well as a keyboard or pointing device. Moreover, the storage device 708 can be local or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, or software. In one embodiment, program modules are stored on the storage device 708, loaded into the memory 706, and executed by the processor 702.

Embodiments of the entities described herein can include other or different modules than the ones described here. In addition, the functionality attributed to the modules can be performed by other or different modules in other embodiments. Moreover, this description occasionally omits the term “module” for purposes of clarity and convenience.

### Other Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

We claim:

1. A computer-implemented method for managing software package dependencies, the method comprising:
receiving, by an online system, a project environment snapshot from a first client device, the project environment snapshot including a dependency graph representing dependencies of one or more packages of a project environment;
storing, by the online system, the project environment snapshot;
receiving, by the online system, a request for the project environment snapshot from a second client device; and
responsive to the request for the project environment snapshot, providing installation information for installing the project environment included in the project environment snapshot to the second client device, the information including the dependency graph.

2. The computer-implemented method of claim 1, wherein storing the project environment snapshot comprises:
receiving a request to cache a compressed version of the project environment from the first client device;
responsive to the request to cache the compressed version, generating a compressed version of the project environment, the compressed version of the project environment including compressed versions of the one or more packages of the project environment; and
caching the compressed version of the project environment at the online system.

3. The computer-implemented method of claim 2, wherein the installation information provided to the second client device includes the compressed version of the project environment.

4. A computer-implemented method for generating a project environment snapshot, the method comprising:
initializing, a software project environment for a client device, the project environment associated with a dependency graph representing dependencies of one or more packages installed for the project environment on the client device;
responsive to a new package being installed for the project environment, updating the dependency graph based on dependencies of the new package;
responsive to receiving a request to generate a project environment snapshot, generating the project environment snapshot based on the updated dependency graph, the project environment snapshot including a static copy of the updated dependency graph; and
providing the project environment snapshot to an online system.

5. The computer-implemented method of claim 4, further comprising:
responsive to an additional package being removed for the project environment, reupdating the dependency graph to remove dependencies of the additional package;
responsive to receiving an additional request to generate an additional project environment snapshot, generating the additional project environment snapshot based on the reupdated dependency graph, the additional project environment snapshot including a static copy of the reupdated dependency graph; and
providing the additional project environment snapshot to the online system.

6. The computer-implemented method of claim 4, further comprising:
responsive to receiving information describing a modification of the dependencies of the new package, reupdating the dependency graph to modify the dependencies of the new package;
responsive to receiving an additional request to generate an additional project environment snapshot, generating the additional project environment snapshot based on the reupdated dependency graph, the additional project environment snapshot including a static copy of the reupdated dependency graph; and
providing the additional project environment snapshot to the online system.

7. The computer-implemented method of claim 4, wherein updating the dependency graph comprises:
identifying, using the dependency graph, a conflict between a dependency of the new package and a dependency of a package installed for the project environment;
determining a configuration of the dependency graph that resolves the identified conflict; and
updating the dependency graph to use the determined configuration.

8. The computer-implemented method of claim 7, wherein determining the configuration of the dependency graph comprises:
responsive to determining that the identified conflict cannot be resolved automatically, providing an interface for display on the client device requesting information for determining the configuration of the dependency graph that resolves the identified conflict; and
receiving the requested information via user interaction with the interface.

9. The computer-implemented method of claim 4, wherein generating the project environment snapshot comprises:
retrieving a set of information describing a current instance of a project environment, the set of information including the static copy of the updated dependency graph; and
generating the project environment snapshot using the information describing the current instance of the project environment.

10. The computer-implemented method of claim 4, wherein the request to generate the project environment snapshot is received based on a user interaction with a user interface of the client device.

11. The computer-implemented method of claim 4, wherein the one or more packages installed for the project environment include instructions represented using a first programming language, and further comprising:
initializing, an additional software project environment for the client device, the additional project environment associated with an additional dependency graph representing dependencies of one or more packages installed for the additional project environment on the client device, the one or more packages installed for the additional project environment including instructions represented using a second programming language;
responsive to receiving a request to generate an additional project environment snapshot for the additional project environment, generating the additional project environment snapshot based on the additional dependency graph; and
providing the additional project environment snapshot to the online system.

12. The computer-implemented method of claim 4, further comprising:
responsive to a predefined period of time elapsing after generating the project environment snapshot, regenerating the project environment snapshot based on a current instance of the dependency graph; and
providing the regenerated project environment snapshot to the online system.

13. The computer-implemented method of claim 4, further comprising:
providing a request to the online system to store the project environment in a compressed format.

14. A computer-implemented method for installing a development environment snapshot, the method comprising:
receiving, by a computing device, a selection of a project environment snapshot stored by an online system, the project environment snapshot associated with one or more packages and including a static dependency graph representing dependencies of the one or more packages;
retrieving the static dependency graph from the online system;
responsive to determining that a compressed version of a package from the one or more packages is cached on the online system, retrieving the compressed package; and
installing the one or more packages in the software development environment using the static dependency graph and the compressed package.

15. The computer-implemented method of claim 14, wherein updating the dependency graph comprises:
responsive to determining that no compressed version of an additional package from the one or more packages is cached on the online system, installing the additional package in the software development environment using dependencies for the additional package described by the static dependency graph.

16. The computer-implemented method of claim 14, wherein updating the dependency graph further comprises:
responsive to determining that no compressed version of an additional package from the one or more packages is cached on the online system, generating a compressed version of the additional package; and
caching the compressed version of the additional package on the online system.

17. The computer-implemented method of claim 14, wherein the project environment snapshot was generated by an additional computing device.

18. The computer-implemented method of claim 14, wherein receiving the selection of the project environment snapshot comprises:
receiving information describing a set of available project environment snapshots from the online system, the set of available project environment snapshots including the project environment snapshot;
providing a user interface for display by the client computing device including the received information; and
receiving a selection of the project environment snapshot from the set of available project environment snapshots via a user interaction with the user interface.

19. The computer-implemented method of claim 14, further comprising:
installing, by the client computing device, a new package in the software development environment;
responsive to installing the new package, updating the static dependency graph based on dependencies of the new package;
providing the updated static dependency graph to the online system.

20. The computer-implemented method of claim 14, wherein installing the one or more packages in the software development environment comprises:
decompressing the compressed package.
